(19) United States
(12) Patent Application Publication
(10) Pub. No.: US 2026/0237566 A1
(43) Pub. Date: Aug. 13, 2026

(54) ELECTROLYTIC CAPACITOR AND METHOD FOR PRODUCING ELECTROLYTIC CAPACITOR

(71) Applicant: Panasonic Intellectual Property Management Co., Ltd., Osaka (JP)

(72) Inventors: TAKEHIRO KOBAYASHI, Osaka (JP); KAZUHIRO TAKATANI, Hyogo (JP)

(21) Appl. No.: 19/153,573

(22) PCT Filed: Feb. 19, 2024
(86) PCT No.: PCT/JP2024/005844

§ 371 Date: Aug. 4, 2025

(30) Foreign Application Priority Data
Feb. 28, 2023 (JP) 2023-030141

(51) Int. Cl. H01G 9/02; H01G 9/00; H01G 9/15

(52) U.S. Cl. CPC H01G 9/02; H01G 9/0029; H01G 9/151

(57) ABSTRACT

An electrolytic capacitor includes a laminate and a liquid component impregnated into the laminate. The laminate includes an anode foil including a dielectric layer disposed on a surface thereof, a cathode foil, a separator, and a conductive polymer layer disposed in the separator. The anode foil and the cathode foil are laminated with the separator interposed therebetween. In the log differential pore volume distribution curve of the separator in which the conductive polymer layer is disposed, a log differential pore volume at the maximum peak in the log differential pore volume distribution curve is in the range from 1.0 cm³/g to 2.3 cm³/g, inclusive.

### TECHNICAL FIELD

The present disclosure relates to an electrolytic capacitor and a method for producing the electrolytic capacitor.

### BACKGROUND

As an electrolytic capacitor, a capacitor in which a capacitor element having a solid electrolyte layer is impregnated with an electrolytic solution is known. For example, in claim 1 of Patent Literature 1 (International Publication WO 2011/099261), “An electrolytic capacitor including: a capacitor element including an anode foil having a dielectric layer on its surface, a cathode foil, a separator interposed between the anode foil and the cathode foil, and a solid electrolyte layer in contact with the dielectric layer of the anode foil and the cathode foil; an electrolytic solution with which the capacitor element is impregnated; and an exterior body that seals the capacitor element together with the electrolytic solution, wherein the electrolytic solution contains a hardly volatile solvent that is at least one of polyalkylene glycol and a derivative of polyalkylene glycol” is described.

### CITATION LIST

### Patent Literature

PTL 1: International Publication WO 2011/099261

### SUMMARY

An aspect of the present disclosure relates to an electrolytic capacitor. The electrolytic capacitor includes a laminate and a liquid component impregnated into the laminate. The laminate includes an anode foil including a dielectric layer disposed on a surface of the anode foil, a cathode foil, a separator, and a conductive polymer layer disposed in the separator. In a log differential pore volume distribution curve of the separator in which the conductive polymer layer is disposed, a log differential pore volume at a maximum peak in the log differential pore volume distribution curve is in a range from 1.0 cm³/g to 2.3 cm³/g, inclusive.

An aspect of the present disclosure relates to a method for producing an electrolytic capacitor. The production method is a method for producing an electrolytic capacitor including a cathode foil and an anode foil including a dielectric layer disposed on a surface of the anode foil, the method including, in this order: a step (i) of forming a conductive polymer layer in a separator using a coating liquid containing a conductive polymer component; a step (ii) of forming a laminate including the conductive polymer layer by laminating the anode foil, the cathode foil, and the separator to interpose the separator between the anode foil and the cathode foil; and a step (iii) of impregnating the laminate with a liquid component. In the step (i), the conductive polymer layer is formed so that a log differential pore volume at a maximum peak in a log differential pore volume distribution curve of the separator in which the conductive polymer layer is formed is in a range from 1.0 cm³/g to 2.3 cm³/g, inclusive.

The present disclosure provides an electrolytic capacitor including a conductive polymer and a liquid component and having low ESR.

### BRIEF DESCRIPTION OF THE DRAWINGS

FIG. 1 is a sectional view schematically illustrating an example of an electrolytic capacitor of the present exemplary embodiment.

FIG. 2 is an exploded perspective view schematically illustrating an example of a capacitor element used in the electrolytic capacitor of FIG. 1.

FIG. 3 is a graph showing results of Examples.

FIG. 4 is a graph showing an example of a log differential pore volume distribution curve.

### DESCRIPTION OF EMBODIMENT

In an electrolytic capacitor including a conductive polymer and a liquid component (such as an electrolytic solution), a reduction in equivalent series resistance (ESR) is required. The present disclosure provides an electrolytic capacitor including a conductive polymer and a liquid component and having low ESR.

Exemplary embodiments according to the present disclosure will be described hereinafter with reference to examples, but the present disclosure is not limited to the examples that will be described below. In the following description, specific numerical values and materials are disclosed as examples in some cases, but other numerical values and materials may be applied as long as the invention according to the present disclosure can be implemented. In this specification, the description “numerical value A to numerical value B” includes a numerical value A and a numerical value B, and can be read as “from numerical value A to numerical value B inclusive”. In the following description, in a case where lower limits and upper limits of numerical values related to specific physical properties, conditions, or the like are illustrated, any of the illustrated lower limits and any of the illustrated upper limits can be arbitrarily combined unless the lower limit is more than or equal to the upper limit.

### (Electrolytic Capacitor)

Hereinafter, an electrolytic capacitor according to the present exemplary embodiment may be referred to as “electrolytic capacitor (E)”. The electrolytic capacitor (E) includes a laminate and a liquid component impregnated into the laminate. Hereinafter, the liquid component may be referred to as a “liquid component (L)”. The laminate includes an anode foil including a dielectric layer formed on a surface of the anode foil, a cathode foil, a separator, and a conductive polymer layer formed in the separator. In the log differential pore volume distribution curve of the separator in which the conductive polymer layer is formed, the log differential pore volume at the maximum peak in the log differential pore volume distribution curve is in the range from 1.0 cm³/g to 2.3 cm³/g, inclusive. The log differential pore volume of the maximum peak may be referred to as a “maximum peak volume Vmax”. The separator in which the conductive polymer layer is disposed may be referred to as a “polymer layer-containing separator”.

The conductive polymer component and the liquid component (L) are disposed between the anode foil and the cathode foil of the electrolytic capacitor (E). Therefore, the electrolytic capacitor (E) can have excellent characteristics. In order for the electrolytic capacitor (E) to exhibit excellent characteristics, it is required to dispose a certain amount or more of the conductive polymer component between the anode foil and the cathode foil. Conventionally, a method for disposing more conductive polymer components between an anode foil and a cathode foil has been sought. However, as a result of investigation, the inventors of the present application have newly found that ESR may decrease when the amount of the conductive polymer component to be disposed is increased. Further, the inventors of the present application have newly found that ESR can be greatly reduced by setting the maximum peak volume Vmax in the log differential pore volume distribution curve of the separator in which the conductive polymer layer is formed to a value within a predetermined range. The present disclosure is based on these new findings.

The maximum peak volume Vmax of the polymer layer-containing separator is 1.0 cm³/g, and may be 1.2 cm³/g or more. The maximum peak volume Vmax is 2.3 cm³/g or less, and may be 1.8 cm³/g or less. The maximum peak volume Vmax may be in the range from 1.2 cm³/g to 2.3 cm³/g, inclusive, in the range from 1.0 cm³/g to 1.8 cm³/g, inclusive, or in the range from 1.2 cm³/g to 1.8 cm³/g, inclusive.

By setting the maximum peak volume Vmax to 1.0 cm³/g or more, it is considered that the liquid component (L) easily permeates into the separator. As a result, it is considered that the liquid component (L) is disposed in the separator with favorable dispersibility, and the ESR decreases. By setting the maximum peak volume Vmax to 2.3 cm³/g or less, it is considered that an increase in ESR due to an excessively small amount of the conductive polymer component can be suppressed.

The average pore size at which the log differential pore volume distribution curve has the maximum peak volume Vmax may be, for example, in the range from 1 μm to 50 μm, inclusive, in the range from 1 μm to 30 μm, inclusive, in the range from 5 μm to 30 μm, inclusive, or in the range from 5 μm to 10 μm, inclusive.

The log differential pore volume distribution curve (dV/d(log D)) is a curve obtained by dividing the differential pore volume dV by the logarithmic difference value d(log D) of the pore size and plotting the obtained value against the average pore size in each section. The log differential pore volume distribution curve may be acquired in a pore size range from 1 μm to 100 μm, inclusive. The log differential pore volume distribution curve is a log differential pore volume distribution curve when the polymer layer-containing separator is in a dry state. That is, the maximum peak volume Vmax is obtained by measuring a log differential pore volume distribution curve of the polymer layer-containing separator not impregnated with the liquid component (L) or the like. The log differential pore volume distribution curve can be measured by a mercury intrusion method as described in Examples.

In the case of measuring the log differential pore volume distribution curve of the polymer layer-containing separator included in the electrolytic capacitor, first, the polymer layer-containing separator is taken out from the electrolytic capacitor, and then the separator is immersed in ethanol to wash the liquid component. Then, the washed separator is dried by heating at 100° C. for 1 hour. Thereafter, a log differential pore volume distribution curve is measured.

The log differential pore volume (hereinafter, may be referred to as “maximum peak volume Vs”) at the maximum peak in the log differential pore volume distribution curve of a single separator (the separator in which the conductive polymer layer is not formed) may be 2.5 cm³/g or more, or 2.9 cm³/g or more, and may be 10 cm³/g or less, or 8 cm³/g or less.

The laminate may further include a second conductive polymer layer formed on at least one surface selected from a dielectric layer (surface of the anode foil) or a surface of the cathode foil. The conductive polymer component constituting the conductive polymer layer (first conductive polymer layer) formed in the separator may be the same as or different from the conductive polymer component constituting the second conductive polymer layer. When the conductive polymer layer is formed on both the surface of the dielectric layer and the cathode foil, the conductive polymer components forming the two conductive polymer layers may be the same or different. The conductive polymer layers formed on the respective members may include the same conductive polymer component or may be composed of the same conductive polymer component. The first conductive polymer layer and the second conductive polymer layer may be in contact with each other at an interface. A mixed region in which the first conductive polymer layer and the second conductive polymer layer are mixed may exist at the interfaces.

The electrolytic capacitor (E) may include an organic compound (C) impregnated into the conductive polymer layer formed in the separator. The organic compound (C) is an organic compound that does not boil at 100° C. at 1 atm. Examples of the organic compound (C) will be described later.

### (Method for Producing Electrolytic Capacitor)

Hereinafter, the method for producing an electrolytic capacitor according to the present exemplary embodiment may be referred to as a “production method (M)”. According to the production method (M), the electrolytic capacitor (E) can be produced. However, the electrolytic capacitor (E) may be produced by a method other than the production method (M). The matters described for the electrolytic capacitor (E) can be applied to the production method (M), and thus redundant description may be omitted. The matters described for the production method (M) may be applied to the electrolytic capacitor (E).

The production method (M) is a method for producing an electrolytic capacitor including a cathode foil and an anode foil including a dielectric layer formed on a surface of the anode foil. The production method (M) includes a step (i), a step (ii), and a step (iii) in this order. These steps will be described below.

### (Step (i))

The step (i) is a step of using a coating liquid containing a conductive polymer component to form a conductive polymer layer in a separator. In the step (i), the conductive polymer layer is formed such that the log differential pore volume at the maximum peak volume Vmax in the log differential pore volume distribution curve of the separator in which the conductive polymer layer is formed is in the range from 1.0 cm³/g to 2.3 cm³/g, inclusive.

In the step (i), a conductive polymer layer is formed on the separator before being incorporated into the laminate. Therefore, unlike the method of forming the laminate and then impregnating the laminate with the coating liquid, in the step (i), it is possible to dispose more amount of the conductive polymer components in the separator. However, the inventors of the present application have found that ESR may increase when the amount of the conductive polymer component disposed in the separator is too large. The reason for this is not clear at present, but it is considered that too large amount of the conductive polymer component disposed in the separator causes the liquid component (L) not to sufficiently permeate into the separator, thereby decreasing the affinity of the conductive polymer component for the surface (dielectric layer on surface of anode foil, surface of cathode foil) of the electrode foil. In contrast, too small amount of the conductive polymer component disposed in the separator causes the effect of reducing the ESR due to the conductive polymer component to inhibit, thereby increasing the ESR. As described above, the ESR can be reduced by forming the conductive polymer layer such that the maximum peak volume Vmax of the polymer layer-containing separator is in the range from 1.0 cm³/g to 2.3 cm³/g, inclusive.

The step (i) may include a step (i-a) and a step (i-b). The step (i-a) is a step of applying a coating liquid including a conductive polymer component and a liquid medium to the separator. The step (i-b) is a step of removing at least a part of the liquid medium from the applied coating liquid to form a conductive polymer layer in the separator.

The liquid medium may include water or may be water. Examples of the conductive polymer component will be described later. The conductive polymer component may be dispersed in the coating liquid in the form of particles.

A method for applying a coating liquid is not limited, and the coating liquid may be applied by a known method. Examples of the method include a method using a coater, a method for spraying a coating liquid, and a method for immersing an object to be applied in the coating liquid. Examples of the method using a coater include a gravure coating method and a die coating method. A method for applying a coating liquid to the separator includes a method for impregnating the separator with the coating liquid. The coating liquid applied to the separator penetrates into the separator, and the conductive polymer layer can be formed over the entire separator in the thickness direction.

The method for removing the liquid medium in the step (i-b) is not limited. The removal of the liquid medium may be performed by heating and/or under reduced pressure, and it is preferable to perform at least heating. The heating temperature may be 100° C. or more, 120° C. or more, or 140° C. or more, and may be 200° C. or less, or 160° C. or less. The heating temperature may be in a range from 100° C. to 200° C., inclusive. Heating time is not particularly limited as long as it is time during which a part of the liquid medium can be appropriately removed. The heating time is in a range from 5 minutes to 60 minutes, inclusive, for example.

The maximum peak volume Vmax of the polymer layer-containing separator can be changed by changing the concentration of the conductive polymer component in the coating liquid, the application amount of the coating liquid, the maximum peak volume Vs of the single separator, and the like. The maximum peak volume Vs of the single separator can be changed by changing the porosity or the like of the single separator in which the conductive polymer layer is not formed. The maximum peak volume Vmax can be reduced by increasing the concentration of the conductive polymer component in the coating liquid. Increasing the application amount of the coating liquid allows the maximum peak volume Vmax to be reduced. Reducing the maximum peak volume Vs of the single separator allows the maximum peak volume Vmax to be reduced. For example, reducing the porosity of the separator allows the maximum peak volume Vmax to be reduced.

As described above, the second conductive polymer layer may be formed on at least one surface(S) selected from the dielectric layer (the surface of the anode foil) or the surface of the cathode foil. The second conductive polymer layer can be formed by the same method as the method described for the step (i-a) and the step (i-b).

In step (i), a conductive polymer layer may be formed on the surface of the dielectric layer (the dielectric layer on the anode foil), the surface of the cathode foil, and the separator. This configuration allows the conductive polymer layer to be formed so as to be continuous from the dielectric layer to the cathode foil facing the dielectric layer.

Hereinafter, the conductive polymer layer formed in the separator may be referred to as a “first conductive polymer layer”. The first conductive polymer layer can be formed on a surface of a fiber or a microporous membrane constituting the separator.

The first conductive polymer layer and the second conductive polymer layer may be composed of the same conductive polymer component, or may include different conductive polymer components. The first conductive polymer layer formed in the separator, the second conductive polymer layer formed on the anode foil (on the dielectric layer), and the second conductive polymer layer formed on the cathode foil may be composed of the same conductive polymer component, or may include different conductive polymer components. In one example, they include the same conductive polymeric component.

(Step (ii))

The step (ii) is a step of forming a laminate including the conductive polymer layer by laminating the anode foil, the cathode foil, and the separator such that the separator is disposed between the anode foil and the cathode foil.

The method for forming the laminate is not limited, and the laminate may be formed by a known method. The laminate may be a wound body. In this case, in the step (ii), the anode foil, the cathode foil, and the separator may be wound such that the separator is disposed between the anode foil and the cathode foil to form a wound body. In the wound body, the anode foil, the cathode foil, and the separator are laminated in a radial direction of the wound body.

The laminate may be formed by laminating a flat anode foil, a flat cathode foil, and a flat separator in one direction. For example, a plurality of anode foils, a plurality of cathode foils, and a plurality of separators may be laminated in one direction to form a laminate. In a typical example of the laminate, the anode foil and the cathode foil are alternately disposed, and the separator is disposed between the anode foil and the cathode foil.

(Step (iii))

The step (iii) is a step of impregnating the laminate (for example, the conductive polymer layer in the laminate) with the liquid component. The liquid component is the liquid component (L) described above. The method for impregnating the laminate with the liquid component (L) is not limited. For example, the laminate may be impregnated with the liquid component (L) by immersing at least a part of the laminate in the liquid component (L). The laminate is disposed in the exterior body, and then the liquid component (L) may be injected into the exterior body to impregnate the laminate (L) with the liquid component (L). Examples of the liquid component (L) will be described later.

### (Coating Liquid)

The coating liquid used in the step (i) includes a conductive polymer component and a liquid medium. If necessary, the coating liquid may include other components. The liquid medium may include water or may be water. The coating liquid may be a dispersion liquid in which particles of the conductive polymer component are dispersed.

The conductive polymer component may contain a conductive polymer and include only the conductive polymer. Alternatively, the conductive polymer component may include a conductive polymer and a dopant.

Examples of the conductive polymer include polypyrrole, polythiophene, polyfuran, polyaniline, polyacetylene, and derivatives thereof. The derivatives include polymers having polypyrrole, polythiophene, polyfuran, polyaniline, and polyacetylene as a basic skeleton. For example, the derivative of polythiophene includes poly(3,4-ethylenedioxythiophene) and the like. These conductive polymers may be used singly or in combination of two or more types thereof. The conductive polymers may be each a copolymer of two or more types of monomers. The conductive polymers each have a weight-average molecular weight that is not particularly limited and that may be in a range from 1000 to 100000, inclusive, for example. A preferable example of the conductive polymer is poly(3,4-ethylenedioxythiophene) (PEDOT).

The conductive polymer may be doped with a dopant. From the viewpoint of suppressing dedoping from the conductive polymer, a polymer dopant is preferably used as the dopant. Examples of the polymer dopant include polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid. These may be used singly or in combination of two or more types thereof. At least some of these may be added in the form of a salt. A preferable example of the dopant is polystyrenesulfonic acid (PSS).

The dopant may contain an acidic group, or may be a polymer dopant containing an acidic group. Examples of the acidic group include a sulfonic acid group and a carboxyl group. The polymer dopant containing an acidic group is a polymer in which at least a part of constituent units contains an acidic group. Examples of such a polymer dopant include the polymer dopants described above.

The dopant has a weight-average molecular weight that is not particularly limited. From the viewpoint of facilitating formation of a homogeneous conductive polymer layer, the dopant may have a weight-average molecular weight in a range from 1000 to 100000, inclusive.

The dopant may be polystyrenesulfonic acid, and the conductive polymer may be poly(3,4-ethylenedioxythiophene). That is, the conductive polymer component may be poly(3,4-ethylenedioxythiophene) doped with polystyrenesulfonic acid.

When a conductive polymer doped with a dopant is used, a coating liquid preferably has a pH that is less than 7.0, and that may be 6.0 or less, or 5.0 or less to suppress dedoping of the dopant. The coating liquid may have a pH that is 1.0 or more, or 2.0 or more.

The conductive polymer component may be present in the coating liquid in the form of particles. The conductive polymer component has a particle size distribution on a volume basis of the particles in which a mode value of a particle size may be 10 nm or more, or 20 nm or more, and may be 1000 nm or less, 500 nm or less, 200 nm or less, or 100 nm or less. The particle size distribution on a volume basis can be acquired using a particle size distribution measurement device of a laser diffraction and scattering type.

The content proportion of water in the coating liquid may be 50% by mass or more, 80% by mass or more, 90% by mass or more, 94% by mass or more, 95% by mass or more, 96% by mass or more, or 97% by mass or more. The content proportion may be 99.5% by mass or less. The content proportion may be in the range from 50% by mass to 99.5% by mass, inclusive, from 94% to 99.5% by mass, inclusive, from 95% to 99.5% by mass, inclusive, from 96% to 99.5% by mass, inclusive, or from 97% to 99.5% by mass, inclusive.

The content proportion of the conductive polymer component in the coating liquid may be 0.5% by mass or more, or 1.0% by mass or more, and may be 6.0% by mass or less, 5.0% by mass or less, 4.0% by mass or less, 3.0% by mass or less, or 2.0% by mass or less. The content proportion may be in the range from 0.5% by mass to 6.0% by mass, inclusive, or in the range from 1.0% by mass to 6.0% by mass, inclusive. In any of these ranges, the upper limit may be 5.0% by mass, 4.0% by mass, 3.0% by mass, or 2.0% by mass. The content proportion is preferably in a range from 1.0% to 3.0%, inclusive, from the viewpoint of excellent physical properties of the coating liquid and temporal stability thereof, and favorable balance between ESR and cost of the electrolytic capacitor. When the coating liquid includes the dopant, mass of the dopant is included in mass of the conductive polymer component.

The mass of the dopant included in the coating liquid is not particularly limited, and may be in the range from 0.1 to 5 times (for example, in the range from 0.5 to 3 times) the mass of the conductive polymer included in the coating liquid.

### (Liquid Component (L))

Examples of the liquid component (L) used in the step (iii) include a non-aqueous solvent and an electrolytic solution. As the electrolytic solution, an electrolytic solution including a non-aqueous solvent and a solute dissolved in the non-aqueous solvent can be used. In this specification, the liquid component (L) may be a component that is a liquid at room temperature (25° C.), or may be a component that is a liquid at a temperature at which the electrolytic capacitor is used.

The non-aqueous solvent used for the liquid component (L) may be an organic solvent, an ionic liquid, or a protic solvent. Examples of the non-aqueous solvent include polyhydric alcohols such as ethylene glycol, propylene glycol, and 1,3-butanediol, cyclic sulfones such as sulfolane (SL), lactones such as γ-butyrolactone (γBL), amides such as N-methylacetamide, N,N-dimethylformamide, and N-methyl-2-pyrrolidone, esters such as methyl acetate, carbonate compounds such as propylene carbonate, ethers such as 1,4-dioxane, ketones such as methyl ethyl ketone, and formaldehyde.

As the non-aqueous solvent, a polymer solvent may be used. Examples of the polymer solvent include polyalkylene glycol, a derivative of polyalkylene glycol, and a compound obtained by substituting at least one hydroxyl group in a polyhydric alcohol with polyalkylene glycol (including a derivative). The examples of the polymer solvent specifically include polyethylene glycol (PEG), polyethylene glycol glyceryl ether, polyethylene glycol diglyceryl ether, polyethylene glycol sorbitol ether, polypropylene glycol, polypropylene glycol glyceryl ether, polypropylene glycol diglyceryl ether, polypropylene glycol sorbitol ether, and polybutylene glycol. The examples of the polymer solvent further include an ethylene glycol-propylene glycol copolymer, an ethylene glycol-butylene glycol copolymer, and a propylene glycol-butylene glycol copolymer. As the non-aqueous solvent, one type of the examples may be used singly, or two or more types thereof may be used in combination.

The liquid component (L) may include a non-aqueous solvent and a base component (base) dissolved in the non-aqueous solvent. The liquid component (L) may include a non-aqueous solvent and a base component and/or an acid component (acid) dissolved in the non-aqueous solvent.

As the acid component, a polycarboxylic acid and a monocarboxylic acid may be used. Examples of the polycarboxylic acid include aliphatic polycarboxylic acids ([saturated polycarboxylic acids such as oxalic acid, malonic acid, succinic acid, glutaric acid, adipic acid, pimelic acid, suberic acid, azelaic acid, sebacic acid, 1,6-decanedicarboxylic acid, and 5,6-decanedicarboxylic acid]; and [unsaturated polycarboxylic acids such as maleic acid, fumaric acid, and itaconic acid]), aromatic polycarboxylic acids (such as phthalic acid, isophthalic acid, terephthalic acid, trimellitic acid, and pyromellitic acid), and alicyclic polycarboxylic acids (such as cyclohexane-1,2-dicarboxylic acid and cyclohexene-1,2-dicarboxylic acid).

Examples of the monocarboxylic acid include aliphatic monocarboxylic acids (1 to 30 carbon atoms) ([saturated monocarboxylic acids such as formic acid, acetic acid, propionic acid, butyric acid, isobutyric acid, valeric acid, caproic acid, enanthic acid, caprylic acid, pelargonic acid, lauric acid, myristic acid, stearic acid, and behenic acid]; and [unsaturated monocarboxylic acids such as acrylic acid, methacrylic acid, and oleic acid]), aromatic monocarboxylic acids (such as benzoic acid, cinnamic acid, and naphthoic acid), and oxycarboxylic acids (such as salicylic acid, mandelic acid, and resorcinol acid).

Among these, maleic acid, phthalic acid, benzoic acid, pyromellitic acid, and resorcinol acid are thermally stable, and are preferably used.

As the acid component, an inorganic acid may be used. Typical examples of the inorganic acid include phosphoric acid, phosphorous acid, hypophosphorous acid, alkyl phosphoric acid ester, boric acid, fluoroboric acid, tetrafluoroboric acid, hexafluorophosphoric acid, benzenesulfonic acid, and naphthalenesulfonic acid. As the acid component, a composite compound of an organic acid and an inorganic acid may be used. Examples of such a composite compound include borodiglycolic acid, borodioxalic acid, and borodisalicylic acid.

The base component may be a compound having an alkyl-substituted amidine group, and examples of the compound include an imidazole compound, a benzimidazole compound, and an alicyclic amidine compound (a pyrimidine compound and an imidazoline compound). Preferable examples specifically include 1,8-diazabicyclo[5,4,0]undecene-7,1,5-diazabicyclo[4,3,0]nonene-5, 1,2-dimethylimidazolinium, 1,2,4-trimethylimidazoline, 1-methyl-2-ethyl-imidazoline, 1,4-dimethyl-2-ethylimidazoline, 1-methyl-2-heptylimidazoline, 1-methyl-2-(3′heptyl) imidazoline, 1-methyl-2-dodecylimidazoline, 1,2-dimethyl-1,4,5,6-tetrahydropyrimidine, 1-methylimidazole, and 1-methylbenzimidazole. Using any of the examples enables obtaining a capacitor excellent in impedance performance.

As the base component, a quaternary salt of a compound having an alkyl-substituted amidine group may be used. Examples of such a base component include an imidazole compound, a benzimidazole compound, and an alicyclic amidine compound (a pyrimidine compound and an imidazoline compound) that are quaternized by an alkyl group or an arylalkyl group having 1 to 11 carbon atoms. Preferable examples specifically include 1-methyl-1,8-diazabicyclo[5,4,0]undecene-7, 1-methyl-1,5-diazabicyclo[4,3,0]nonene-5, 1,2,3-trimethylimidazolinium, 1,2,3,4-tetramethylimidazolinium, 1,2-dimethyl-3-ethylimidazolinium, 1,3,4-trimethyl-2-ethylimidazolinium, 1,3-dimethyl-2-heptylimidazolinium, 1,3-dimethyl-2-(3′heptyl) imidazolinium, 1,3-dimethyl-2-dodecylimidazolinium, 1,2,3-trimethyl-1,4,5,6-tetrahydropyrimidium, 1,3-dimethylimidazolium, 1-methyl-3-ethylimidazolium, and 1,3-dimethylbenzimidazolium. Using any of the examples enables obtaining a capacitor excellent in impedance performance.

As the base component, a tertiary amine may be used. Examples of the tertiary amine include trialkylamines (such as trimethylamine, dimethylethylamine, methyldiethylamine, triethylamine, dimethyl-n-propylamine, dimethylisopropylamine, methylethyl-n-propylamine, methylethylisopropylamine, diethyl-n-propylamine, diethylisopropylamine, tri-n-propylamine, triisopropylamine, tri-n-butylamine, and tri-tert-butylamine) and phenyl group-containing amines (such as dimethylphenylamine, methylethylphenylamine, and diethylphenylamine). Among them, the trialkylamines are preferable in terms of high conductivity, and containing at least one kind selected from the group consisting of trimethylamine, dimethylethylamine, methyldiethylamine, and triethylamine is more preferable. As the base component, a secondary amine such as dialkylamines, a primary amine such as a monoalkylamine, or ammonia may also be used.

The liquid component (L) may contain a salt of an acid component with a base component. The salt may be an inorganic salt and/or an organic salt. The organic salt is a salt in which at least one of an anion and a cation contains an organic substance. Examples of the organic salt include trimethylamine maleate, triethylamine borodisalicylate, ethyldimethylamine phthalate, mono 1,2,3,4-tetramethylimidazolinium phthalate, and mono 1,3-dimethyl-2-ethylimidazolinium phthalate.

To suppress dedoping of the dopant, the liquid component (L) may have a pH of less than 7.0, or 5.0 or less, or a pH of 1.0 or more, or 2.0 or more. The pH may be 1.0 or more and less than 7.0 (e.g., in a range from 2.0 to 5.0, inclusive).

The liquid component (L) preferably includes a protic solvent. The liquid component (L) includes a protic solvent, thereby providing an excellent effect. The liquid component (L) may include a solvent other than the protic solvent in addition to the protic solvent.

The protic solvent may include at least one selected from the group consisting of glycols, glycerin, polyglycerin, and sugar alcohols, and may be the at least one. The protic solvent may be composed of only one compound or may include a plurality of compounds.

The organic compound (C) and the liquid component (L) may include the same compound. For example, they may include the same protic solvent, may include the same polyhydric alcohol, may include the same glycols (such as ethylene glycol), or may include the same sugar alcohol.

The production method (M) may include a step (x) and a step (y) in this order between the step (ii) and the step (iii). Performing the steps (x) and (y) makes it possible to further reduce the ESR.

### (Step (x))

The step (x) is a step (x) of impregnating the conductive polymer layer in the laminate with a liquid including water and an organic compound (C) that does not boil at 100° C. at 1 atm (101325 Pa). Hereinafter, the liquid may be referred to as a “liquid (S)”. The main component (content: 50% by mass or more) of the liquid (S) may be water.

The method for impregnating the conductive polymer layer with the liquid (S) is not limited. For example, the liquid (S) may be applied to the conductive polymer layer by immersing at least a part of the laminate in the liquid (S). The maximum peak volume Vmax is in the above-described range, causing the conductive polymer layer to be easily impregnated with the liquid (S), thereby allowing ESR to be particularly reduced.

### (Liquid (S))

The liquid (S) includes water and the organic compound (C) as described above. The liquid (S) may be composed of water and the organic compound (C) or may include other components. As the organic compound (C), an organic compound that is easily dissolved in water can be preferably used. The organic compound (C) may be a compound having miscibility with water. Examples of the organic compound (C) include a compound used as an organic solvent. Examples of the organic compound (C) include polyhydric alcohols having two or more hydroxyl groups.

The liquid (S) may or may not include the conductive polymer. The liquid (S) is a liquid having the conductive polymer layer as an action target, and thus the liquid (S) preferably does not substantially include the conductive polymer. For example, the content proportion of the conductive polymer in the liquid (S) may be less than 0.5% by mass or less than 0.1% by mass. When the liquid (S) includes a conductive polymer component, the conductive polymer component included in the conductive polymer layer and the conductive polymer component included in the liquid (S) may be the same or different.

In this specification, the boiling point means a boiling point at 1 atm unless otherwise specified. Examples of the organic compound (C) include organic compounds having a boiling point more than 100° C. When the organic compound (C) has a boiling point, the boiling point may be 110° C. or more, 150° C. or more, or 200° C. or more, and may be 400° C. or less, 300° C. or less, 250° C. or less, or 200° C. or less. The boiling point may be in a range from 110° C. to 400° C., inclusive (e.g., in a range from 150° C. to 350° C., inclusive).

Examples of the organic compound (C) include a polyhydric alcohol, sulfolane, γ-butyrolactone, and a boric ester. The organic compound (C) may include at least one selected from the group consisting of a polyhydric alcohol, sulfolane, γ-butyrolactone, and a boric ester, and may be the at least one. The organic compound (C) may include at least one selected from the group consisting of glycols, glycerins, sugar alcohols, sulfolane, γ-butyrolactone, and boric esters, and may be the at least one.

Examples of the polyhydric alcohol include glycols, glycerins, and sugar alcohols. Examples of the glycols include ethylene glycol, diethylene glycol, triethylene glycol, polyalkylene glycol (for example, polyethylene glycol), and polyoxyethylene polyoxypropylene glycol (ethylene oxide-propylene oxide copolymer). Examples of the glycerins include glycerin and polyglycerin. Examples of the sugar alcohols include mannitol, xylitol, sorbitol, erythritol, and pentaerythritol.

The organic compound (C) may be a protic solvent. Examples of the protic solvent will be described later. As the organic compound (C), glycols (ethylene glycol or the like) are preferable from the viewpoint of obtaining an excellent effect.

The content proportion of water in the liquid (S) is, for example, 40% by mass or more, and may be 50% by mass or more, 70% by mass or more, 90% by mass or more, or 95% by mass or more. The content proportion is preferably 99% by mass or less, or 98% by mass or less, and may be 95% by mass or less, 90% by mass or less, 80% by mass or less, or 50% by mass or less. The content proportion may be in the range from 40% by mass to 99% by mass, inclusive, in the range from 50% by mass to 99% by mass, inclusive, in the range from 70% by mass to 99% by mass, inclusive, or in the range from 90% by mass to 99% by mass, inclusive. In any of these ranges, the upper limit may be replaced with 98% by mass, 95% by mass, 90% by mass, 80% by mass, or 50% by mass as long as the lower limit is not equal to or more than the upper limit.

The content proportion of the organic compound (C) in the liquid (S) may be 1% by mass or more, 2% by mass or more, 3% by mass or more, 5% by mass or more, 10% by mass or more, or 20% by mass or more. The content proportion may be 60% by mass or less, 50% by mass or less, 40% by mass or less, or 30% by mass or less. The content proportion may be in the range from 1% by mass to 60% by mass, inclusive, from 2% by mass to 60% by mass, inclusive, from 3% by mass to 60% by mass, inclusive, from 5% by mass to 60% by mass, inclusive, or from 10% by mass to 60% by mass, inclusive. In any of these ranges, the upper limit may be replaced with 50% by mass, 30% by mass, 25% by mass, or 20% by mass. The content proportion is preferably in the range from 2% by mass to 50% by mass, inclusive, and more preferably in the range from 5% by mass to 50% by mass, inclusive.

In the liquid (S), the content proportion of water (% by mass) and the content proportion of the organic compound (C) (% by mass) may be in the range from 99:1 (or 98:2) to 50:50 (or 60:40)=water content proportion: organic compound (C) content proportion.

### (Step (y))

A step (y) is a step of removing a part of the liquid with which the conductive polymer layer is impregnated while remaining the organic compound (C) in the conductive polymer layer. The time from the step (x) to the step (y) is not particularly limited, and the step (y) may be performed immediately after the step (x) is performed. Alternatively, the step (y) may be performed after a time in the range from 1 minute to 360 minutes (for example, a range from 5 minutes to 180 minutes) has elapsed since the step (x) was performed.

When all of the liquid (S) is removed, shrinkage of the conductive polymer layer increases. By increasing shrinkage of the conductive polymer layer, equivalent series resistance (ESR) of the electrolytic capacitor is increased. In addition, when the conductive polymer layer shrinks largely, the dense conductive polymer covers the dielectric film formed on the surface of the anode foil. Hence, the liquid component (L) to be described later is less likely to come into contact with the surface of the dielectric layer. As a result, the function of forming the dielectric layer (oxide film) by the liquid component (L) is not sufficiently exerted, and thus may cause an increase in leak current or a short circuit. By removing the liquid (S) such that the organic compound (C) remains, it is possible to produce the electrolytic capacitor having low ESR and low leak current, thereby exhibiting high reliability.

The step (x) and step (y) are preferably performed such that the mass of the organic compound (C) in the conductive polymer layer is larger than the mass of water in the conductive polymer layer by the step (y). That is, in the conductive polymer layer after the step (y) is performed and before another step is performed, the mass of the organic compound (C) in the layer is preferably larger than the mass of water in the layer. The amount of water remaining in the conductive polymer layer increases, thereby deteriorating characteristics of the electrolytic capacitor. Therefore, in the step (y), a part of liquid (S) is preferably removed so as to reduce the amount of water remaining in the conductive polymer layer.

The liquid (S) may be removed by heating and/or under reduced pressure, and performing at least heating is preferable. When heating is performed, a part of the liquid (S) is preferably removed by heating the laminate at a temperature of 100° C. or more. Performing heating at a temperature of 100° C. or more allows water in the liquid (S) to be rapidly removed. Heating temperature is preferably a temperature at which the organic compound (C) does not boil or decompose. When the organic compound (C) is a compound having no clear boiling point, the heating is preferably performed at a temperature at which the organic compound (C) evaporates a little and the organic compound (C) is not decomposed. The heating temperature may be 100° C. or more, 120° C. or more, or 140° C. or more, and may be 250° C. or less, 200° C. or less, or 160° C. or less. The heating temperature may be in the range from 100° C. to 200° C., inclusive (e.g., in the range from 100° C. to 160° C., inclusive). Heating time is not particularly limited as long as a part of the liquid (S) can be appropriately removed in time. The heating time is in a range from minutes 5 minutes to 60 minutes, inclusive, for example.

The step (x) and step (y) may be performed such that the ratio of the mass Wc of the organic compound (C) remaining in the conductive polymer layer to the mass Wp of the conductive polymer component in the conductive polymer layer, Wc/Wp, is 1.0 or more and 20 or less. The ratio Wc/Wp may be 1.0 or more, 1.2 or more, or 2.0 or more, and may be 20 or less, or 18 or less. The ratio Wc/Wp may be in a range from 1.0 to 20, inclusive, from 1.2 to 18, inclusive, or from 2.0 to 18, inclusive. By setting the ratio Wc/Wp to the range from 2.0 to 18, inclusive, an electrolytic capacitor having particularly favorable characteristics can be obtained. When Wc/Wp is increased, the content proportion of the organic compound (C) in the liquid (S) may be increased, or the amount of the liquid (S) applied may be increased.

In the step (y), a part of the liquid (S) is removed such that the ratio of the mass Ww of water in the conductive polymer layer to the mass We of the organic compound (C) in the conductive polymer layer, Ww/Wc, is less than 1. Ww/Wc may be 0 or more, 0.001 or more, 0.1 or more, or 0.2 or more, and may be 0.9 or less, 0.8 or less, 0.5 or less, 0.2 or less, 0.1 or less, or 0.005 or less. In order to reduce Ww/Wc, for example, a method for increasing the content proportion of the organic compound (C) in the liquid (S), a method for reducing the content proportion of water in the liquid (S), a method for performing the step (y) under a condition that water preferentially evaporates, or the like can be used.

The mass Ww can be measured by a Karl Fischer titration method. The mass Wp can be calculated from the concentration of the conductive polymer component in the dispersion liquid (coating liquid) including the conductive polymer component and the mass of the dispersion liquid used for forming the conductive polymer layer.

The mass Wc is calculated by the following procedure. First, the mass W0 (initial) of the laminate (capacitor element) after the laminate forming step and before the liquid applying step is measured. Then, the mass W1 (after treatment) of the laminate after performing the liquid applying step and the removing step is measured. Then, the mass Wc can be calculated from the mass difference (W1−W0) between the mass W1 after the treatment and the initial mass W0. When most of the water in the liquid (S) with which the laminate is impregnated is removed by the removing step, the mass difference (W1−W0) can be regarded as the mass Wc. The mass Ww of moisture remaining in the conductive polymer layer may be obtained by the Karl Fischer titration method, and (W1−W0−Ww) may be set as Wc.

An example of the configuration and constituent elements of the electrolytic capacitor (E) will be described below. The electrolytic capacitor as an example to be described below includes a capacitor element, an exterior body, an anode lead terminal, and a cathode lead terminal. The configuration and configuration elements of the electrolytic capacitor (E) are not limited to the following examples.

The electrolytic capacitor (E) includes a laminate and a liquid component (L) impregnated into the laminate. The laminate includes a conductive polymer layer. The laminate functions as a capacitor element. The laminate includes an anode foil including a dielectric layer formed on a surface thereof, a cathode foil, and a separator disposed between the anode foil and the cathode foil. The anode foil and the cathode foil face each other with the separator interposed therebetween. The electrolytic capacitor (E) typically includes an exterior body in which the laminate is sealed.

The electrolytic capacitor includes at least one capacitor element, and may include a plurality of capacitor elements. The number of capacitor elements included in the electrolytic capacitor may be determined in accordance with application.

### (Anode Foil)

Examples of the anode foil include a metal foil containing at least one of valve metal such as titanium, tantalum, aluminum, and niobium, and metal foil made of a valve metal (e.g., aluminum foil). The anode foil may contain the valve metal in a form such as an alloy containing the valve metal or a compound containing the valve metal. A thickness of the anode foil may be 15 μm or more and 300 μm or less. The anode foil has a surface that may be roughened by etching or the like.

On the surface of the anode foil, a dielectric layer is formed. The dielectric layer may be formed by subjecting the anode foil to an anodizing treatment. In this case, the dielectric layer may include an oxide of a valve metal (for example, aluminum oxide). The dielectric layer only needs to function as a dielectric material, and thus may be made of a dielectric material other than an oxide of a valve metal.

The electrolytic capacitor may include the anode foil with an end surface without a conductive polymer layer. Meanwhile, the end surface of the anode foil is desirably provided with a dielectric layer.

### (Cathode Foil)

The cathode foil is not particularly limited as long as it has a function as a cathode. Examples of the cathode foil include a metal foil (e.g., aluminum foil). The metal is not particularly limited in kind, and may be a valve metal or an alloy containing a valve metal. The thickness of the cathode foil may be 15 μm or more and 300 μm or less. The cathode foil has a surface that may be roughened or subjected to anodizing treatment as necessary.

The cathode foil may include a conductive covering layer. When the metal foil used for a cathode foil includes a valve metal, the covering layer may include carbon and at least one kind of metal having a lower ionization tendency than the valve metal. This configuration facilitates improvement in acid resistance of the metal foil. When the metal foil contains aluminum, the covering layer may include at least one selected from the group consisting of carbon, nickel, titanium, tantalum, and zirconium. Among others, the covering layer may include nickel and/or titanium in terms of low cost and resistance.

A thickness of the covering layer may be 5 nm or more or 10 nm or more, and may have 200 nm or less. The covering layer may be formed by depositing or sputtering the metal on the metal foil. Alternatively, the covering layer may be formed by depositing a conductive carbon material on the metal foil or applying a carbon paste including a conductive carbon material on the metal foil. Examples of the conductive carbon material include graphite, hard carbon, soft carbon, and carbon black.

### (Separator)

A porous sheet can be used as the separator. Examples of the porous sheet include a woven fabric, a nonwoven fabric, and a microporous membrane. A preferable example of the porous sheet is a nonwoven fabric. The separator is not particularly limited in thickness, and may have a thickness in a range from 10 μm to 300 μm, inclusive. Examples of a material for the separator include cellulose, polyethylene terephthalate, polybutylene terephthalate, polyphenylenesulfide, vinylon, nylon, aromatic polyamide, polyimide, polyamideimide, polyetherimide, rayon, and glass.

### (Exterior Body)

The exterior body includes a case and/or a sealing resin. There is no limitation thereto, and a known case and a sealing resin may be used. The sealing resin may include a thermosetting resin. Examples of the thermosetting resin include an epoxy resin, phenol resin, silicone resin, melamine resin, urea resin, alkyd resin, polyurethane, polyimide, and unsaturated polyester. The sealing resin may include a filler, curing agent, polymerization initiator, catalyst, and/or the like.

Hereinafter, an example of the present exemplary embodiment will be specifically described with reference to the drawings. The one example is described below with components to which the components described above are applicable. In addition, components of one example described below can be changed based on the above description. Matters described below may be applied to the exemplary embodiment described above. The one example described below may exclude components that are not essential to the electrolytic capacitor of the present disclosure.

### First Exemplary Embodiment

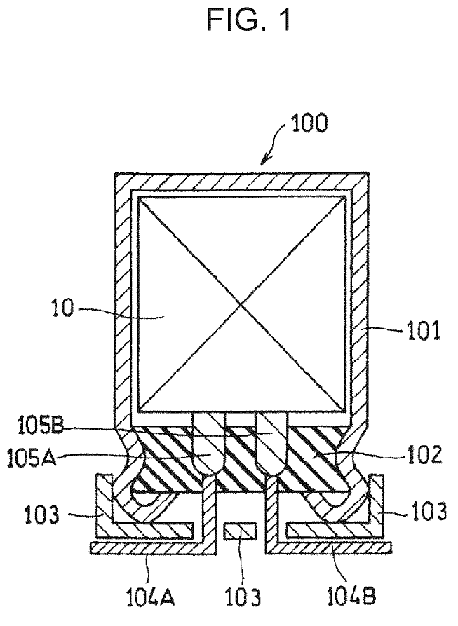

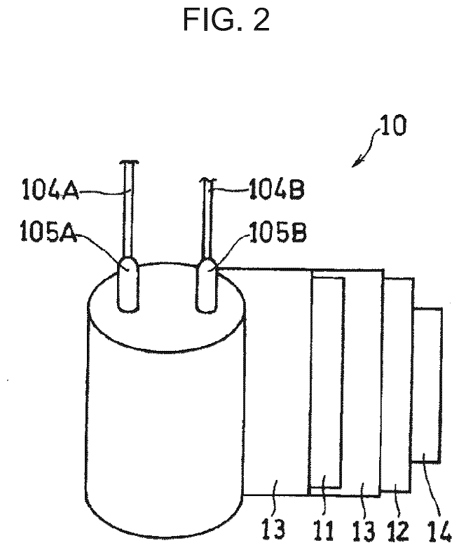

FIG. 1 is a sectional view schematically illustrating an example of electrolytic capacitor 100 according to first exemplary embodiment. FIG. 2 is a partially developed schematic view of capacitor element 10 included in electrolytic capacitor 100.

Electrolytic capacitor 100 includes capacitor element 10, bottomed case 101 that houses capacitor element 10, sealing member 102 that closes an opening of bottomed case 101, seat plate 103 that covers sealing member 102, lead wires 104A, 104B led out from sealing member 102 and penetrating seat plate 103, and lead tabs 105A, 105B connecting the lead wires and the electrodes of capacitor element 10. The vicinity of an opening end of bottomed case 101 is drawn inward, and the opening end is curled to be clinched to sealing member 102.

Capacitor element 10 is, for example, a wound body as illustrated in FIG. 1. The wound body includes anode foil 11 connected to lead tab 105A, cathode foil 12 connected to lead tab 105B, and separator 13. Capacitor element (wound body) 10 includes a conductive polymer layer (not illustrated) formed in separator 13. The maximum peak volume Vmax of separator 13 in which the conductive polymer layer is formed falls within the above-described range. Electrolytic capacitor 100 includes liquid component (L) (for example, an electrolytic solution) with which capacitor element 10 is impregnated.

A dielectric layer (not illustrated) is formed on a surface of anode foil 11. Anode foil 11 and cathode foil 12 are wound with separator 13 interposed between the anode foil and the cathode foil. An outermost circumference of the wound body is fixed with winding stop tape 14. FIG. 2 illustrates a state in which a part of the wound body is unrolled before the outermost circumference of the wound body is fixed.

### SUPPLEMENTARY NOTE

The following techniques are disclosed by the above description.

### (Technique 1)

An electrolytic capacitor, including:
a laminate; and
a liquid component impregnated into the laminate, in which:
the laminate includes:
   an anode foil including a dielectric layer disposed on a surface of the anode foil,
   a cathode foil,
   a separator, and
   a conductive polymer layer disposed in the separator,
the anode foil and the cathode foil are laminated with the separator disposed between the anode foil and the cathode foil, and
in a log differential pore volume distribution curve of the separator in which the conductive polymer layer is disposed, a log differential pore volume at a maximum peak in the log differential pore volume distribution curve is in a range from 1.0 cm³/g to 2.3 cm³/g, inclusive.

### (Technique 2)

A method for producing an electrolytic capacitor including a cathode foil and an anode foil including a dielectric layer disposed on a surface of the anode foil, the method including, in this order:
a step (i) of forming a conductive polymer layer in a separator using a coating liquid containing a conductive polymer component;
a step (ii) of forming a laminate including the conductive polymer layer by laminating the anode foil, the cathode foil, and the separator to interpose the separator between the anode foil and the cathode foil; and
a step (iii) of impregnating the laminate with a liquid component,
in which in the step (i), the conductive polymer layer is formed so that a log differential pore volume at a maximum peak in a log differential pore volume distribution curve of the separator in which the conductive polymer layer is formed is in a range from 1.0 cm³/g to 2.3 cm³/g, inclusive.

### (Technique 3)

The method according to technique 2, further including:
between the step (ii) and the step (iii),
a step (x) of impregnating the conductive polymer layer with a liquid including water and an organic compound that does not boil at 100° C. at 1 atm; and
a step (y) of removing a part of the liquid with which the conductive polymer layer is impregnated while remaining the organic compound in the conductive polymer layer.

### EXAMPLES

Although the present disclosure will be described below in more detail based on examples, the present disclosure is not limited to the examples. In this example, a plurality of electrolytic capacitors were fabricated and evaluated by the following method.

### (Capacitor A1)

First, an anode foil, a cathode foil, and a polymer layer-containing separator were prepared. As the anode foil, an aluminum foil with the surface roughened by etching was used. A dielectric layer (aluminum oxide layer) was formed on the surface of the aluminum foil by subjecting the surface of the aluminum foil to an anodizing treatment. An aluminum foil was used as the cathode foil.

The polymer layer-containing separator was prepared by the following procedure. As the separator, a separator including natural cellulose was used. The maximum peak volume Vs in the log differential pore volume distribution curve of the single separator was 2.9 cm³/g. A coating liquid containing a conductive polymer component was applied to the separator and then dried to form a conductive polymer layer in the separator. As described above, a polymer layer-containing separator was obtained. As the coating liquid, a dispersion liquid in which a conductive polymer component was dispersed in water was used. Poly(3,4-ethylenedioxythiophene) (PEDOT) doped with polystyrene sulfonic acid (PSS) was used as the conductive polymer component.

Then, a polymer layer-containing separator, an anode foil including a dielectric layer formed on a surface thereof, and a cathode foil were wound to form a capacitor element. In this case, each member was wound such that the separator was disposed between the anode foil and the cathode foil.

Then, the capacitor element was immersed in a liquid (S) including water and an organic compound (C) that did not boil at 100° C. at 1 atm, thereby impregnating the capacitor element with the liquid (S). As described above, the conductive polymer layer was impregnated with the liquid (S). As the organic compound (C), polyethylene glycol was used.

Then, water in the capacitor element was removed by heating the capacitor element such that the organic compound (C) remained in the conductive polymer layer. The heating was performed at a temperature of 135° C. for 20 minutes.

Then, the capacitor element (laminate) was impregnated with the liquid component (L) by immersing the capacitor element in the liquid component (L). This capacitor element was subjected to heat treatment. Then, the anode foil of the capacitor element was subjected to an anodizing treatment again.

The laminate subjected to the above steps was sealed in an exterior body to fabricate a capacitor A1.

### (Capacitors A2 to A4 and C1 to C3)

Capacitors A2 to A4 and C1 to C3 were fabricated under the same conditions and by the same method as in the fabrication of the capacitor A1 except that the maximum peak volume Vmax of the polymer layer-containing separator was changed as shown in Table 1. The maximum peak volume Vmax was changed by changing the mass of the conductive polymer component contained in the separator. As the separator, the same separator as the separator used for producing the capacitor A1 was used.

### (Evaluation)

### (1) Measurement of Maximum Peak Volume Vmax

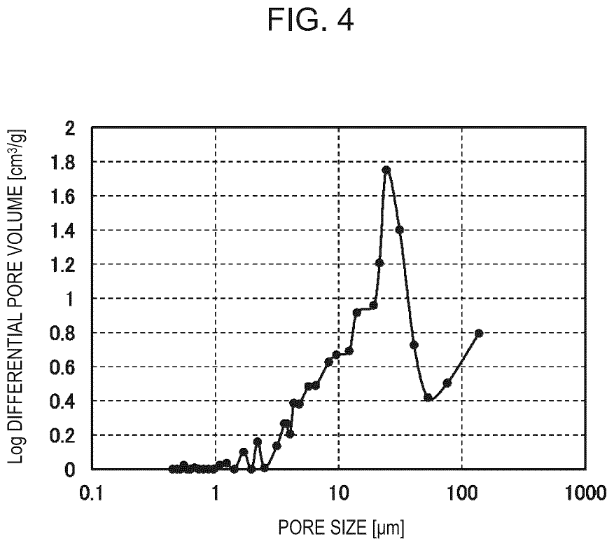

The maximum peak volume Vmax of the separator in which the conductive polymer layer was formed was measured by the following method. First, a sample (area: 10 cm²) having a size of about 100 mm×10 mm was cut out from the separator in which the conductive polymer layer was formed. The sample was folded and placed in a measurement cell, and the pore distribution was measured by a mercury intrusion method. The measurement was performed under the conditions of an initial pressure of about 0.5 psia and a final pressure of about 420 psia. The measurement was performed using AutoPore V manufactured by Micromeritics Instrument Corporation. A log differential pore volume distribution curve was obtained by the measurement. Then, from the distribution curve, the log differential pore volume (maximum peak volume Vmax) of the maximum peak was obtained. FIG. 4 shows the results of measuring the log differential pore volume distribution of an example of a polymer layer-containing separator used in the electrolytic capacitor (E).

### (2) Measurement of Equivalent Series Resistance (ESR) of Electrolytic Capacitor

ESR was measured for the fabricated electrolytic capacitor.

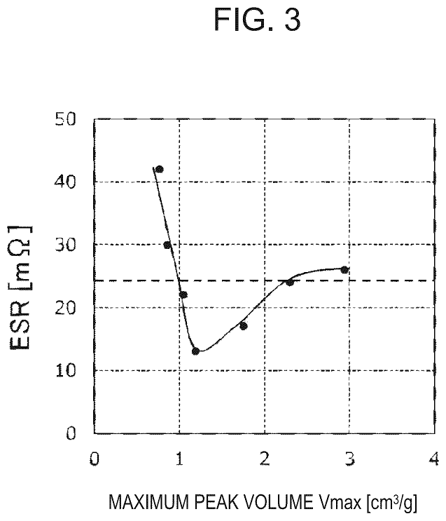

Evaluation results are shown in Table 1. In addition, the relationship between the maximum peak volume Vmax and the ESR shown in Table 1 is shown in FIG. 3.

TABLE 1

| | Maximum peak volume | ESR |
|---|---|---|
| Capacitor | (cm³/g) | (mΩ) |
| C1 | 2.9 | 26 |
| A1 | 2.3 | 24 |
| A2 | 1.8 | 17 |
| A3 | 1.2 | 13 |
| A4 | 1.0 | 22 |
| C2 | 0.9 | 30 |
| C3 | 0.8 | 42 |

The capacitors A1 to A4 are electrolytic capacitors (E) produced by the production method (M). The capacitors C1 to C3 are comparative examples. As shown in Table 1 and FIG. 3, the maximum peak volume Vmax was in the range from 1.0 cm³/g to 2.3 cm³/g, allowing the ESR to be significantly reduced. The ESR of the capacitors C1 to C3 in which the maximum peak volume Vmax was not in this range was high.

### INDUSTRIAL APPLICABILITY

The present disclosure can be used for an electrolytic capacitor.

### REFERENCE MARKS IN THE DRAWINGS

10: capacitor element
11: anode foil
12: cathode foil
13: separator
14: winding stop tape
100: electrolytic capacitor
101: bottomed case
102: sealing member

1. An electrolytic capacitor, comprising:
a laminate; and
a liquid component impregnated into the laminate, wherein:
the laminate includes:
an anode foil including a dielectric layer disposed on a surface of the anode foil,
a cathode foil,
a separator, and
a conductive polymer layer disposed in the separator,
the anode foil and the cathode foil are laminated with the separator disposed between the anode foil and the cathode foil, and
in a log differential pore volume distribution curve of the separator in which the conductive polymer layer is disposed, a log differential pore volume at a maximum peak in the log differential pore volume distribution curve is in a range from 1.0 cm³/g to 2.3 cm³/g, inclusive.

2. A method for producing an electrolytic capacitor comprising a cathode foil and an anode foil including a dielectric layer disposed on a surface of the anode foil, the method comprising, in this order:
a step (i) of forming a conductive polymer layer in a separator using a coating liquid containing a conductive polymer component;
a step (ii) of forming a laminate including the conductive polymer layer by laminating the anode foil, the cathode foil, and the separator to interpose the separator between the anode foil and the cathode foil; and
a step (iii) of impregnating the laminate with a liquid component,
wherein in the step (i), the conductive polymer layer is formed so that a log differential pore volume at a maximum peak in a log differential pore volume distribution curve of the separator in which the conductive polymer layer is formed is in a range from 1.0 cm³/g to 2.3 cm³/g, inclusive.

3. The method according to claim 2, further comprising:
between the step (ii) and the step (iii),
a step (x) of impregnating the conductive polymer layer with a liquid including water and an organic compound that does not boil at 100° C. at 1 atm; and
a step (y) of removing a part of the liquid with which the conductive polymer layer is impregnated while remaining the organic compound in the conductive polymer layer.
